(19) United States
(12) Patent Application Publication
(10) Pub. No.: US 2010/0277597 A1
(43) Pub. Date: Nov. 4, 2010

(54) System and Method for Photo-Image Discovery and Storage

(76) Inventors: Dimitry Vaysburg, Livermore, CA (US); Vinay Ravuri, Santa Clara, CA (US); Prodyut Hazarika, Mountain View, CA (US); Loc Ho, San Jose, CA (US); Tushar Tyagi, Sunnyvale, CA (US); Paramesh Gopi, Cupertino, CA (US); Dmitriy Shtalenkov, Foster City, CA (US); Vidhyananth Venkatasamy, Sunnyvale, CA (US); Gilles Garcia, Palo Alto, CA (US); Fushen Chen, San Jose, CA (US); Victor Gallardo, Chula Vista, CA (US)

Correspondence Address: LAW OFFICE OF GERALD MALISZEWSKI, P.O. BOX 270829, SAN DIEGO, CA, 92198-2829, US

(21) Appl. No.: 12/431,914

(22) Filed: Apr. 29, 2009

(51) Int. Cl. H04N 5/225; H04N 5/76; H04N 5/228

(52) U.S. Cl. 348/207.1; 348/231.99; 348/231.2; 348/E05.024; 348/E05.031

(57) ABSTRACT

A system and method are provided for automatic photo-image discovery and storage. A photo-image discovery device scans communication interfaces for photo-capable devices. The photo-image discovery device is capable of concurrently scanning wireless and hardwired connector interfaces. A determination is made of whether the detected photo-capable devices have stored electronically formatted photo-images, which may be either still or video images. The photo-images are acquired into the photo-image discovery device. Then, the acquired photo-images are automatically uploaded to a network-connected storage site.

### BACKGROUND OF THE INVENTION

1. Field of the Invention

This invention generally relates to electronic image storage and more particularly to a system and method for the automatic uploading of images to a network-connected storage site via a photo-image discovery device.

2. Description of the Related Art

Conventional technology permits a user to connect their camera or memory card to a personal computer (PC), open a software application in the PC, and upload images for local storage. Once the images are stored, the user may select images for local printing, organize folders, or create a CD. Further, the images may be uploaded to a network-connected storage site vendor, such as Costco. Once the images are uploaded, the user may select images for printing, and have the printed pictures prepared for pickup or delivery. Otherwise, the user can have the images archived.

Unfortunately, these operations are cumbersome and require extensive human interaction. Further, a minimal amount of technical acumen is required to perform these operations, and if the user is technophobic, the images may remain in the camera until they are lost, erased, or overwritten.

Eye-Fi™ is a wireless memory card that automatically uploads any images on the card, via a WiFi (IEEE 802.11) link, to a user's PC for local storage, or to a network-connected storage site. Unfortunately, the images remain on the memory card until the user comes within range of a WiFi access point (AP). The user cannot upload their images via a public AP unless the card has been previously preconfigured. Such an operation would require the use of a PC and a related software application. Due to the relatively long time it takes to upload a single image, the system is only practical for user who has a personal (home) WiFi AP. Further, while the automatic upload feature is a convenience, the user has lost all ability to edit and organize the images leaving the camera, and it is not necessarily easy to organize the images once they have been uploaded. Finally, the user is unaware of which, if any, images have been successfully uploaded until they inventory their storage.

It would be advantageous if images could be automatically acquired from a camera to an intermediate storage device, without a WiFi link or PC.

It would be advantageous if new images could be automatically uploaded to a network-connected storage using an intermediary discovery and organization device.

It would also be advantageous if a user received feedback to indicate whether images have been successfully uploaded.

### SUMMARY OF THE INVENTION

A system and method are disclosed herein that are capable of acquiring images from a variety of different sources, such as a digital camera, camcorder, 3G phone, cell phone, or personal computer (PC), and upload them into an Internet-connected storage/processing service. Once stored, the images can be printed, archived, or used in any manner, as if the storage was local.

Accordingly, a method is provided for automatic photo-image discovery and storage. In a first step, a photo-image discovery device scans communication interfaces for photo-capable devices. The photo-image discovery device is capable of concurrently scanning wireless and hardwired connector interfaces. A determination is made of whether the detected photo-capable devices have stored electronically formatted photo-images, which may be either still or video images. The photo-images are acquired into the photo-image discovery device. Then, the acquired photo-images are automatically uploaded to a selected network-connected storage site, in accordance with that storage site's format policy.

In one aspect, the photo discovery determines if the detected photo-images have been previously acquired. Only photo-images that have not been previously acquired are acquired for uploading. Subsequent to acquiring the photo-images, a photo-image discovery device user interface (UI) indicates that the photo-images have been acquired. Likewise, subsequent to uploading the photo-images to the storage site, the photo-image discovery device UI indicates that the photo-images have been successfully transferred.

In the event of a failure to acquire the photo-images into the photo-image discovery device, the photo-image discovery device UI indicates that the photo-images have not been successfully acquired. Likewise, the UI indicates if the acquired photo-images fail to successfully upload.

Additional details of the above-described method and a photo-image discovery device are provided below.

### BRIEF DESCRIPTION OF THE DRAWINGS

FIG. 1 is a schematic block diagram of a photo-image discovery device.

FIG. 2 is a diagram depicting a first exemplary image organization transaction.

FIG. 3 is a diagram depicting a second exemplary image organization transaction.

FIGS. 4A and 4B depict two exemplary processes for configuring the photo-image discovery device of FIG. 1.

FIG. 5 is a diagram depicting the photo-image discovery device from a functional perspective.

FIG. 6 is a flowchart illustrating a method for automatic photo-image discovery and storage.

### DETAILED DESCRIPTION

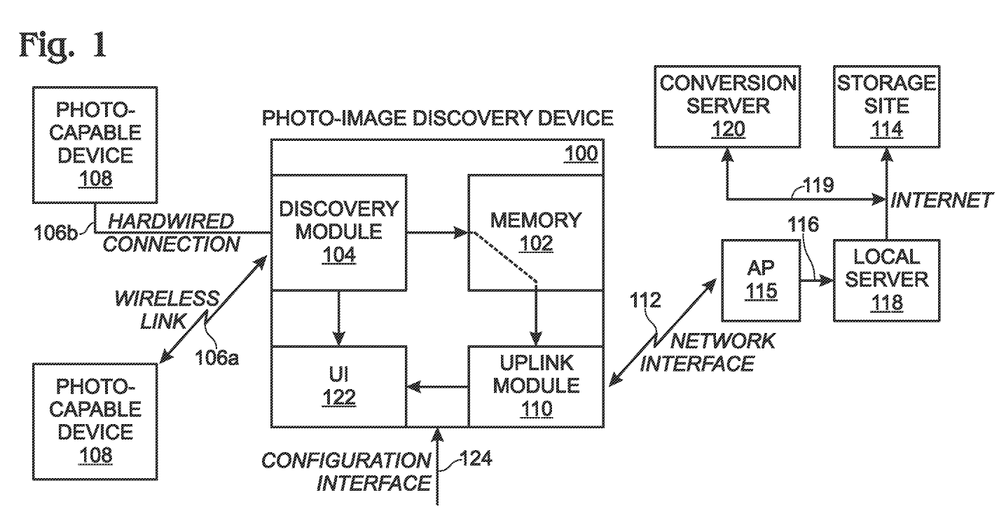

FIG. 1 is a schematic block diagram of a photo-image discovery device. The photo-image discovery device 100 comprises a memory 102 and a discovery module 104 having a scanning interface on line 106 for detecting photo-capable devices. In one aspect, the discovery module scanning interface concurrently scans wireless and hardwired connector interfaces. The wireless interface is represented by reference designator 106a and the hardwire connector interface by reference designator 106b. For simplicity, only a single wireless and single hardwired interface are shown. However, it should be understood that multiple such interfaces may be required for different protocols, frequencies, and connector types.

Some examples of the wireless interface 106a include Bluetooth, wireless USB, and IEEE 802.11 (WiFi) interfaces. However, the device 100 is not limited to just these examples. Some examples of hardwire connector interface 106b include Universal Serial Bus (USB) and SD memory card interfaces. Some examples of photo-image file types include JPEG, GIF, EXIF, native format, BMP, CR2, RAW, and MPEG. Again, the system is not limited to just these exemplary file types and interfaces.

The discovery module 104 determines if detected photo-capable devices 108 have stored electronically formatted photo-images, and if so, acquires the photo-images into the memory 102. If the detected photo-images have been previously acquired into the memory, the photo-images are not reacquired. Some examples of photo-capable devices include a cellular telephone, 3G cell phone, a personal computer (PC), controlled automation device, digital video disk (DVD) device, camera-enabled wireless device, video-enabled wireless device, television, digital video recorder (DVR), secure digital (SD) memory card, digital camera, and game console. Some examples of a controlled automation device include home camera security system and a remotely programmable DVR. In one aspect, the discovery module 104 acquires photo-images from only preconfigured photo-capable devices 108. That is, the discovery module 104 will only acquire photo-images from a limited group of devices with which it has been given permission to act. In this manner, the photo-image discovery device will not “accidentally” acquire images from unauthorized sources. The photo-image discovery device enters photo-capable device configuration commands via a built-in user interface (UI) 122, or via a configuration interface 124, as explained in more detail below.

An uplink module 110 has a network interface on line 112. The uplink module 110 automatically uploads the photo-images in the memory 102 to a network-connected storage site 114. Although only a single storage site is shown for simplicity, it should be understood that the photo-image discovery device is able to communicate with any number of storage sites. The photo-image discovery device may send the same photo-images to more than one storage site. In one aspect, the uplink module 110 uploads photo-images via a WiFi interface to a network-connected server 114. As shown, a WiFi access point (AP) 115 wirelessly receives information from the photo-image discovery device, transfers the information via a landline 116 to a local server 118, which then uses an Internet protocol to transfer the information to storage server 114 via line 119. However, it would be possible to upload photo-images using other nodes or other protocols to reach the storage site.

Typically, the discovery module 104 acquires and stores the photo-images into memory in the first format, and the uplink module 110 uploads the acquired photo-image in the first format. In one aspect, the discovery module uploads photo-images in a first format (e.g., JPEG) and converts the photo-images to a second format (e.g., GIF). Then, the uplink module 110 uploads photo-images in the second format to the storage site 114. Alternately, the discovery module 104 acquires photo-images in a first format and the uplink module 110 uploads the photo-images to a network-connected conversion device 120 for conversion into a second format. In one aspect, the converted photo-images are returned to the photo-discovery device 100 for uplink to the storage site 114. Alternately, the conversion device transfers the converted photo-images to the storage site directly, via line 119.

In a different aspect, the photo-images may be uploaded and downloaded in the same file format, but can have image attributes changed such as the resolution, compression ratio, red-eye removal. The attributes changed would be dependent upon the attribute parameters associated with the storage device or destination.

In another aspect, the uplink module 110 has an interface for receiving storage site selection commands and transfers the photo-images to at least one selected storage site. The commands may be entered via a built-in user interface (UI) 122, or communicated via a configuration interface 124, as explained in more detail below. The uplink module 110 may determine a photo-image format associated with the selected storage and direct the discovery module or conversion site to convert acquired photo-images to the format associated with the selected storage device.

In one aspect, the UI 122 receives a signal from the uplink module 110 subsequent to uploading the photo-images to the storage site, indicating that the photo-images have been successfully uploaded. In turn, the UI 122 supplies an indication to the user of a successful upload. Likewise, in the event of a failure to upload the photo-images to the storage site, the uplink module 110 may supply a signal to the UI, and the UI supply a prompt to the user, indicating that the photo-images have not been successfully uploaded.

For example, the UI may be a light emitting diode (LED), or a set of LEDs, where LED groups, LED flash patterns, or LED colors signify different events. In another aspect, the UI 122 may incorporate a visual display, such as a liquid crystal display (LCD). Further, the UI 122 may incorporate buttons, switches, a keypad, or a mouse to accept user commands. In one aspect, the discovery module 104 automatically acquires photo-images from devices. However, in another aspect the discovery module only acquires photo-images in response to a UI prompt. That is, the UI 122 indicates that photo-images are available for acquisition, and the user must affirmatively authorize acquisition using a UI button, switch, or the like.

In a similar manner, if the discovery module 104 fails to acquire the photo-images into the memory, it supplies a signal to the UI indicating that the photo-images have not been successfully acquired. In turn, the UI 122 supplies some kind of indicator to the user. Likewise, if the discovery module 104 successfully acquires the photo-images into the memory, it supplies a signal to the UI 122, and the UI 122 supplies an appropriate indicator to the user.

The discovery module 104 may also organize acquired photo-images into folders using criteria such as user, the photo-image discovery device ID, file types, or the photo-capable device originating the photo-images, to name a few examples. The folders may be established in memory 102. Alternately, instructions may accompany the uplinked photo-images, so that folders are created at the storage site 114, and the photo-images stored in the corresponding folder types.

It is difficult for a user to remember the circumstances associated with each of their photos. This problem is compounded when the user is faced with the daunting task of remembering, sorting, and organizing photos on a camera memory card filled with hundreds of pictures. Conventional processes that simply move the photos from one storage site (i.e. the memory card) to a second storage site (i.e. a PC or network-connected storage site) do not adequately address this problem.

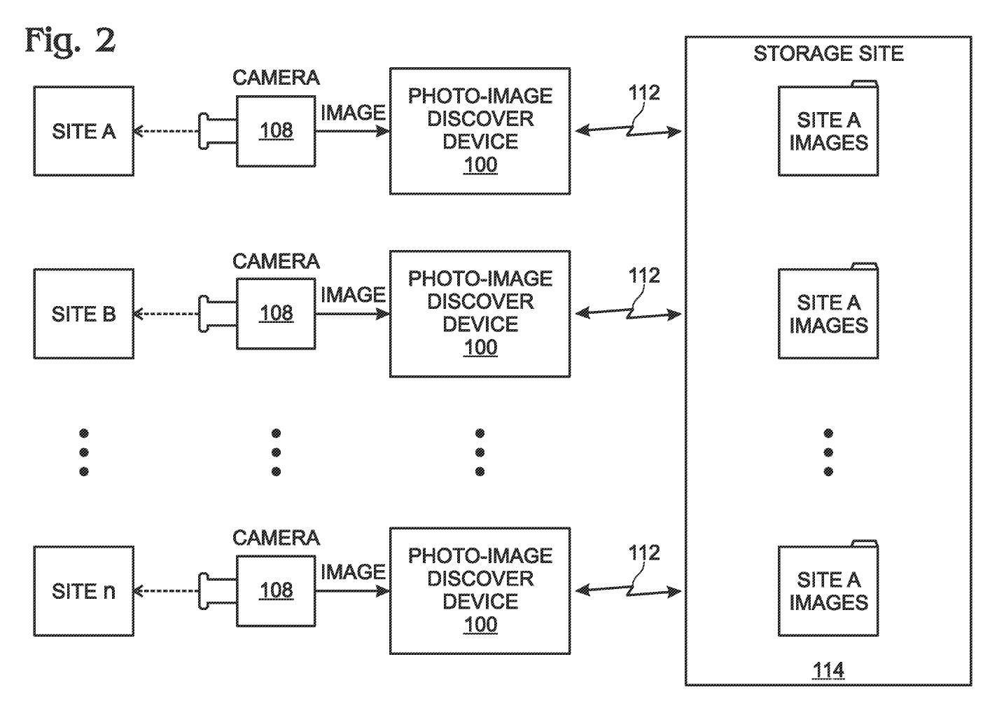

FIG. 2 is a diagram depicting a first exemplary image organization transaction. The photo-image discovery device disclosed herein advantageously acts as an intermediary between images stored on a camera device and storage, giving the user the opportunity to organize images. Some of this organization is performed using the mechanisms already described above. For example, the photo-image discovery device may be preconfigured to separate the images associated with each acquisition/upload operation into a separate folder. If the user is a tourist in Rome, they may choose to manually acquire/upload images after each attraction (sites A through n) they visit. In that manner, the photos associated with each attraction are automatically organized into separate folders at the storage site.

FIG. 3 is a diagram depicting a second exemplary image organization transaction. As another example, the photo-image discovery device may be configured to acquire images from two cameras. If there is a different user associated with each camera, the photo-image discovery device is automatically insuring that the acquired/uplinked photo-images are being saved in different folders differentiated by user (camera).

More complicated organizational schemes may be pre-configured or implemented on-the-fly if the UI 122 is sophisticated enough. Alternately, if the UI 122 is simple (i.e. a set of LEDs), the configuration interface 124 may be used to enter commands.

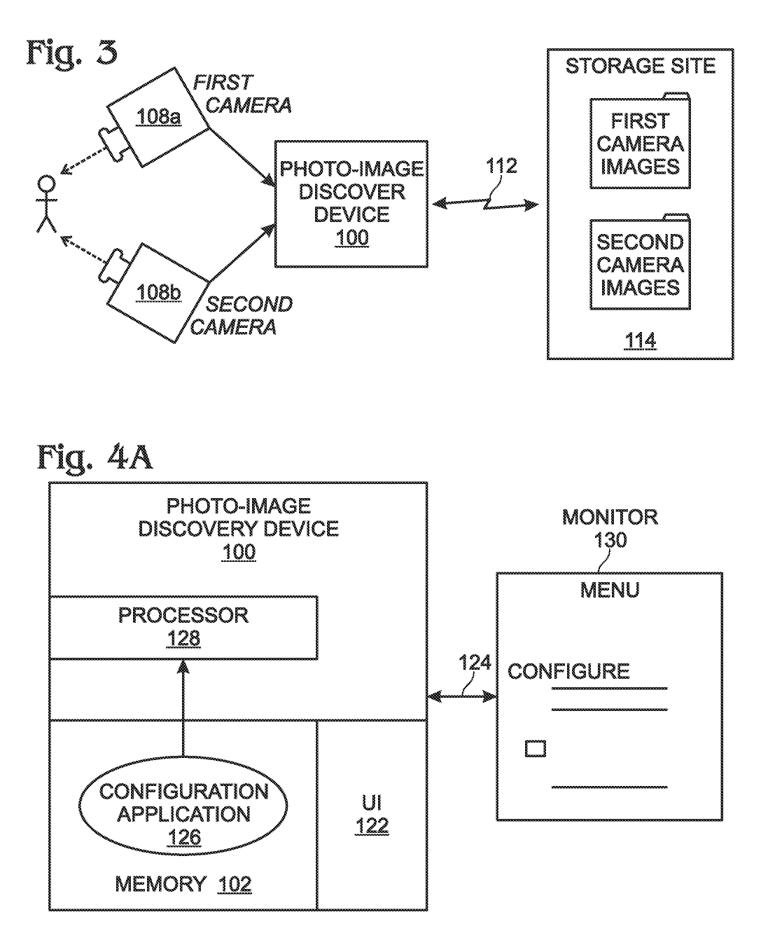

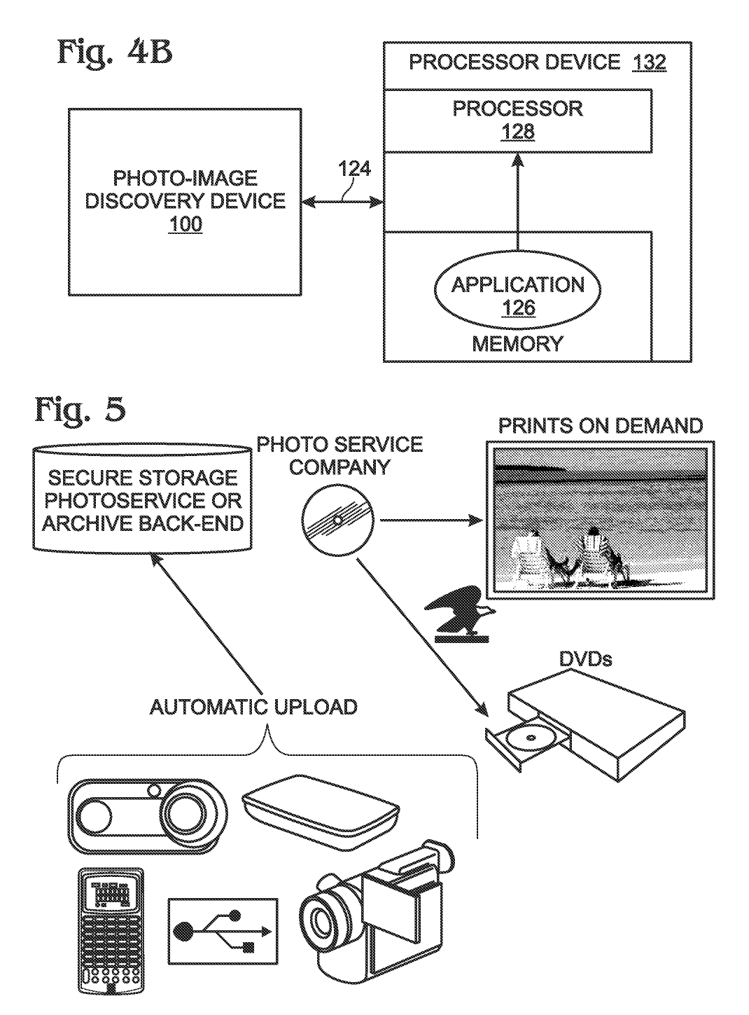

FIGS. 4A and 4B depict two exemplary processes for configuring the photo-image discovery device of FIG. 1. The configuration interface 124 is described in more detail in a related application to follow. Generally, as shown in FIG. 4A, the configuration interface is wirelessly or hardwire connected to a simple monitor 130, such as a television screen. A configuration software application 126 is stored in memory 102 and enabled as processor instructions. The instructions are executed by processor 128. By executing instructions in the configuration application, the photo-image discovery device is able to generate a menu of instruction prompts and menu options on monitor 130. The user is able to navigate through the menu of prompts and options using the UI 122 (e.g., buttons or keypad). In one aspect, the photo-image discovery device is able to make selections as a wireless point-and-click device.

In another variation (FIG. 4B), the configuration software application 126 resides in a microprocessor device 132 such as a PC or cell phone. Changes and modifications to the photo-image discovery device are made by running the configuration application on the PC. Then, the changes can be loaded into the photo-image discovery device via the configuration interface 124.

### Functional Description

Conventionally, a user must perform many steps to store their pictures into a website for sharing, printing, or archiving. Further, a large proportion of these users either do not own a PC, or they are uncomfortable using a PC. These users would like to store, edit, print, and archive their pictures and video clips without having to go thru an intermediate step requiring the use of a PC.

To that end, the photo-image discovery device described in FIG. 1 automates the upload of files from devices such as a digital camera, 3G phones, and cell phone to a backend service by reducing/eliminating the user intervention. Reduced user intervention accelerates the availability of photo-images for sharing, viewing, protecting, and printing. Unlike conventional automatic acquisition technology, the photo-image discovery device disclosed herein is not limited to a single kind of image media, single image source, or single image destination.

FIG. 5 is a diagram depicting the photo-image discovery device from a functional perspective. In one aspect, a digital camera or SD memory card is connected to the photo-image discovery device using a USB cable. The photo-image discovery device automatically transfers pictures, video clips, files to its memory/storage and asynchronously starts to upload those files, thru WiFi, to an archive backend service or picture website.

From a cell phone, a Bluetooth connection is established (pairing), and images acquired from the cell phone through the Bluetooth connection are uploaded to the backend service or the picture website. From a 3G phone, a WiFi connection is established with the photo-image discovery device and WiFi link is used to acquire pictures and video clips. A second WiFi link is used to transfer images from the photo-image discovery device to the backend service or picture website.

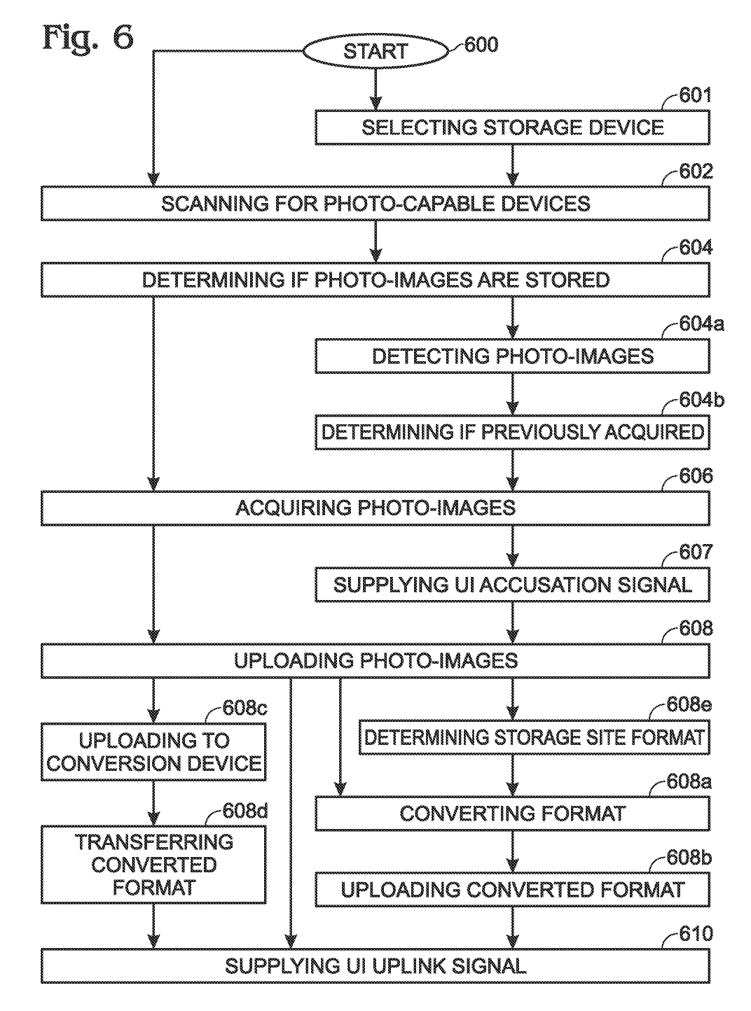

FIG. 6 is a flowchart illustrating a method for automatic photo-image discovery and storage. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. The method starts at Step 600.

In Step 602 a photo-image discovery device scans communication interfaces for photo-capable devices. Step 602 may separately or concurrently scan wireless and hardwired connector interfaces. That is, the photo-image discovery device is capable of scanning either type of interface. For example, the wireless interface may be Bluetooth, wireless USB, or WiFi. Some examples of a hardwire connector interface include USB and SD memory card interfaces.

Step 604 determines if detected photo-capable devices have stored electronically formatted photo-images. Some examples of photo-capable devices include a cellular telephone, PC, controlled automation device, DVD device, camera-enabled wireless device, video-enabled wireless device, television, DVR, SD memory card, a wireless SD memory card, digital camera, and game console. Some examples of photo-image file types include JPEG, GIF, EXIF, native format, BMP, CR2, RAW, and MPEG.

Step 606 acquires the photo-images into the photo-image discovery device. In one aspect, the photo-image discovery device automatically acquires the photo-images. Alternately, the photo-images are acquired in response to supplying a UI prompt. In another aspect, Step 606 additionally organizes the photo-images into folders using criteria such as user, the photo-image discovery device transferring the photo-images, file types, and the photo-capable device originating the photo-images. In another variation, the photo-image discovery device only acquires photo-images from preconfigured photo-capable devices.

Step 608 automatically uploads the acquired photo-images to a network-connected storage site. As noted earlier, the uplink typically employs a WiFi network in the link between the photo-image discovery device and the storage server.

In one aspect, determining if detected photo-capable devices have stored photo-images in Step 604 includes substeps. Step 604a detects photo-images in a photo-capable device memory, and Step 604b determines if the detected photo-images have been previously acquired. For example, the photo-image discovery device may keep a record of previously acquired image identification numbers that may accompany an image. Then, Step 606 acquires only photo-images that have not been previously acquired.

In another aspect, subsequent to uploading the photo-images to the storage site, Step 610 supplies a photo-image discovery device user interface signal indicating that the photo-images have been successfully uploaded. A separate UI indicator signal may also be used to signify an unsuccessful upload. In a related aspect, subsequent to acquiring the photo-images into the photo-image discovery device, Step 607 supplies a photo-image discovery device UI signal indicating that the photo-images have been successfully acquired. Likewise, Step 607 may supply a different UI signal to signify that the photo-images have been unsuccessfully acquired.

In a simple variation, acquiring the photo-images in Step 606 includes acquiring photo-images in a first format, and Step 608 uploads the photo-images in the first format. Alternately, the acquired photo-images may be uploaded to the storage site in substeps. Step 608a converts the photo-images to a second format, and Step 608b uploads photo-images in the second format to the storage site. Alternately, Step 608c uploads the photo-images to a network-connected conversion device, and Step 608d transfers photo-images in the second format from the conversion device to the storage device.

In a related aspect, the method may include a step (Step 601) of selecting at least one storage device from a plurality of storage sites. Then, uploading the downloaded photo-images to the storage site in Step 608 includes uploading the photo-images to the selected storage site. Substep 608e may determine a photo-image format associated with the selected storage device (e.g., the second format). Then, Step 608a converts acquired photo-images to the format associated with the selected storage device.

A system and method have been provided for automatic photo-image discovery. Examples of specific processes and hardware modules have been given to illustrate the invention. However, the invention is not limited to merely these examples. Other variations and embodiments of the invention will occur to those skilled in the art.

We claim:

1. A method for automatic photo-image discovery and storage, the method comprising:
a photo-image discovery device scanning communication interfaces for photo-capable devices;
determining if detected photo-capable devices have stored electronically formatted photo-images;
acquiring the photo-images into the photo-image discovery device; and,
automatically uploading the acquired photo-images to a network-connected storage site.

2. The method of claim 1 wherein determining if detected photo-capable devices have stored photo-images includes:
detecting photo-images in a photo-capable device memory;
determining if the detected photo-images have been previously acquired; and,
wherein acquiring the photo-images includes acquiring only photo-images that have not been previously acquired.

3. The method of claim 1 further comprising:
subsequent to uploading the photo-images to the storage site, supplying a photo-image discovery device user interface (UI) signal indicating that the photo-images have been successfully uploaded.

4. The method of claim 1 wherein scanning communication interfaces for photo-capable devices includes concurrently scanning wireless and hardwired connector interfaces.

5. The method of claim 4 wherein scanning wireless interfaces includes concurrently scanning wireless interfaces selected from a group consisting of Bluetooth, wireless USB, and IEEE 802.11 (WiFi) interfaces.

6. The method of claim 4 wherein concurrently scanning wireless interface includes scanning for photo-capable devices selected from a group consisting of a cellular telephone, personal computer (PC), controlled automation device, digital video disk (DVD) device, camera-enabled wireless device, video-enabled wireless device, television, digital video recorder (DVR), secure digital (SD) memory card, a wireless SD memory card, digital camera, and game console.

7. The method of claim 4 wherein concurrently scanning electronic connector interfaces includes scanning hardwire connector interfaces selected from a group consisting of Universal Serial Bus (USB) and SD memory card interfaces.

8. The method of claim 1 wherein determining if detected photo-capable devices have stored photo-images includes detecting photo-image file types selected from a group consisting of JPEG, GIF, EXIF, native format, BMP, CR2, RAW, and MPEG.

9. The method of claim 1 wherein uploading the acquired photo-images to the network-connected storage site includes uploading photo-images via a WiFi interface to a network-connected server.

10. The method of claim 9 wherein acquiring the photo-images includes organizing the photo-images into folders using a criteria selected from a group consisting of user, the photo-image discovery device transferring the photo-images, file types, and the photo-capable device originating the photo-images.

11. The method of claim 1 wherein acquiring the photo-images includes acquiring photo-images in a first format;
wherein uploading the acquired photo-images to the storage site includes:
converting the photo-images to a second format; and,
uploading photo-images in the second format to the storage site.

12. The method of claim 1 wherein acquiring the photo-images includes acquiring photo-images in a first format;
wherein uploading the acquired photo-images to the storage device includes:
uploading the photo-images to a network-connected conversion device; and,
transferring photo-images in the second format from the conversion device to the storage device.

13. The method of claim 1 further comprising:
selecting at least one storage device from a plurality of storage sites; and,
wherein uploading the downloaded photo-images to the storage site includes uploading the photo-images to the selected storage site.

14. The method of claim 13 further comprising:
determining a photo-image format associated with the selected storage device; and,
converting acquired photo-images to the format associated with the selected storage device.

15. The method of claim 1 wherein acquiring the photo-image includes storing the photo-image in the photo-image discovery device in the first format; and,
wherein uploading the acquired photo-images to the storage site includes uploading the acquired photo-image in the first format.

16. The method of claim 1 wherein acquiring the photo-images into the photo-image discovery device includes an acquisition operation selected from a group consisting of automatically acquiring and acquiring in response to supplying a UI prompt.

17. The method of claim 1 further comprising:
subsequent to acquiring the photo-images into the photo-image discovery device, supplying a photo-image discovery device UI signal indicating that the photo-images have been successfully acquired.

18. The method of claim 1 wherein acquiring the photo-images into the photo-image discovery device includes acquiring photo-images from only preconfigured photo-capable devices.

19. The method of claim 1 further comprising:
in the event of a failure to upload the photo-images to the storage site, supplying a photo-image discovery device UI indicating that the photo-images have not been successfully uploaded.

20. The method of claim 1 further comprising:
in the event of a failure to acquire the photo-images into the photo-image discovery device, supplying a photo-image discovery device UI indicating that the photo-images have not been successfully acquired.

21. A photo-image discovery device comprising:
a memory;
a discovery module having a scanning interface for detecting photo-capable devices, the discovery module determining if detected photo-capable devices have stored electronically formatted photo-images, and acquiring the photo-images into the memory; and,
an uplink module having a network interface, the uplink module automatically uploading the photo-images in the memory to a network-connected storage site.

22. The device of claim 21 wherein the discovery module detects photo-images in a photo-capable device memory, determines if the detected photo-images have been previously acquired into the memory, and acquires only photo-images that have not been previously acquired.

23. The device of claim 21 wherein the discovery module supplies a signal to a UI subsequent to acquiring the photo-images into memory, indicating that the photo-images have been successfully acquired; and,
the device further comprising:
a UI to supply a user signal indicating that the photo-images have been successfully acquired.

24. The device of claim 21 wherein the discovery module scanning interface concurrently scans wireless and hardwire connector interfaces.

25. The device of claim 24 wherein the discovery module scanning interface scans wireless interfaces selected from a group consisting of Bluetooth, wireless USB, and IEEE 802.11 (WiFi) interfaces.

26. The device of claim 24 wherein the discovery module scanning interface scans for photo-capable devices selected from a group consisting of a cellular telephone, personal computer (PC), controlled automation device, digital video disk (DVD) device, camera-enabled wireless device, video-enabled wireless device, television, digital video recorder (DVR), secure digital (SD) memory card, digital camera, and game console.

27. The device of claim 24 wherein the discovery module scanning interface scans hardwire connector interfaces selected from a group consisting of Universal Serial Bus (USB) and SD memory card interfaces.

28. The device of claim 21 wherein discovery module scanning interface scans photo-image file types selected from a group consisting of JPEG, GIF, EXIF, native format, BMP, CR2, RAW, and MPEG.

29. The device of claim 21 wherein the uplink module uploads photo-images via a WiFi interface to a network-connected server.

30. The device of claim 29 wherein the discovery module acquires the photo-images into memory as folders organized using a criteria selected from a group consisting of user, the photo-image discovery device ID, file types, and the photo-capable device originating the photo-images.

31. The device of claim 21 wherein the discovery module uploads photo-images in a first format and converts the photo-images to a second format; and,
wherein the uplink module uploads photo-images in the second format to the storage site.

32. The device of claim 21 wherein the discovery module acquires photo-images in a first format; and,
wherein the uplink module uploads the photo-images to a network-connected conversion device for conversion into a second format.

33. The device of claim 21 wherein the uplink module has an interface for receiving storage site selection commands and transfers the photo-images to at least one selected storage site.

34. The device of claim 33 wherein the uplink module determines a photo-image format associated with the selected storage; and,
wherein the discovery module converts acquired photo-images to the format associated with the selected storage device.

35. The device of claim 21 wherein the discovery module acquires and stores the photo-images into memory in the first format; and,
wherein the uplink module uploads the acquired photo-image in the first format.

36. The device of claim 21 wherein the discovery module supports an acquisition operation selected from a group consisting of automatically acquiring and acquiring in response to a UI prompt.

37. The device of claim 21 wherein the uplink module supplies a signal to a UI subsequent to uploading the photo-images to the storage site, indicating that the photo-images have been successfully uploaded.
the device further comprising:
a UI to supply a user signal indicating that the photo-images have been successfully uploaded.

38. The device of claim 21 further wherein the discovery module acquires photo-images from only preconfigured photo-capable devices.

39. The device of claim 21 wherein the uplink module, in the event of a failure to upload the photo-images to the storage site, supplies a signal to a UI indicating that the photo-images have not been successfully uploaded; and,
the device further comprising:
a UI to supply a user signal indicating that the photo-images have not been successfully uploaded.

40. The device of claim 21 wherein the discovery module, in the event of a failure to acquire the photo-images into the memory, supplies a signal to a UI indicating that the photo-images have not been successfully acquired; and,
the device further comprising:
a UI to supply a user signal indicating that the photo-images have not been successfully acquired.
